(19) United States
(12) Patent Application Publication
(10) Pub. No.: US 2025/0094751 A1
(43) Pub. Date: Mar. 20, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: KEI TOMINAGA, Ibaraki (JP)

(21) Appl. No.: 18/828,600

(22) Filed: Sep. 9, 2024

(30) Foreign Application Priority Data
Sep. 15, 2023 (JP) 2023-149904

(51) Int. Cl. G06K 15/02

(52) U.S. Cl. CPC G06K 15/1805; G06K 15/1813; G06K 15/1831

(57) ABSTRACT

Provided is an image processing apparatus for generating bitmap data based on PDL data, including: an obtaining unit configured to obtain the PDL data; an identification unit configured to, in a case where PDL data including a command indicating repetitively drawing of a pattern in a predetermined range in a page is obtained, identifies the pattern defined in the command; and a control unit configured to store image data of the identified pattern in a memory, in which the control unit controls the storage of the image data of the identified pattern such that a single piece of image data is stored for same patterns in the memory.

### BACKGROUND

### Field

The present disclosure relates to a process of creating bitmap data from page description language (hereinafter referred to as “PDL”) data.

### Description of the Related Art

Data describing the content of an image in a PDL (hereinafter referred to as “PDL data”) has been known as print job data for instructing an image forming apparatus to perform printing. An image forming apparatus receives and interprets such PDL data to generate bitmap data, and prints an image on a print medium based on the generated bitmap data. The PDL data is sent to the image forming apparatus from a printing control apparatus (computer).

Japanese Patent Laid-Open No. 2017-97463 discloses a PDL data generation method in which Extensible Markup Language (XML) Paper Specification (XPS) data is converted using one method for portions to be drawn with repetitions of a pattern and another method for other portions to generate PDL data with Printer Command Language (PCL).

Meanwhile, there are images in which drawing regions are expressed with repetitions of a unit image (hereinafter referred to as “pattern”), such as watermarks. In PDL data, the content of an image like a watermark is described in the form of a pattern command including various types of information such as pattern information, size information, and an identifier that identifies the pattern.

PDL data generated may differ by the printer driver incorporated in the printing control apparatus. For example, PDL data may be generated such that a plurality of the same patterns are defined in a region in which one type of watermark is to be drawn. In a case of generating bitmap data based on such PDL data, a plurality of the same patterns are stored in a memory, and the watermark is drawn with them. Thus, in the case of drawing the watermark based on the PDL data, the required memory region may be large, thus increasing the load of the drawing process. Adding a hardware resource to solve this problem will increase the cost.

### SUMMARY

An image processing apparatus of the present disclosure is an image processing apparatus for generating bitmap data based on PDL data, including: an obtaining unit configured to obtain the PDL data; an identification unit configured to, in a case where PDL data including a command indicating repetitively drawing of a pattern in a predetermined range in a page is obtained, identifies the pattern defined in the command; and a control unit configured to store image data of the identified pattern in a memory, in which the control unit controls the storage of the image data of the identified pattern such that a single piece of image data is stored for same patterns in the memory.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an image forming apparatus;

FIG. 2 is a diagram illustrating a configuration of a printer controller unit;

FIG. 3 is a block diagram illustrating a function framework of the image forming apparatus associated for operations for image processing;

FIGS. 4A and 4B are diagrams illustrating examples of images represented by pattern commands contained in PDL data;

FIG. 5 is a diagram illustrating a pattern command included in PDL data;

FIG. 6 is a diagram illustrating a pattern command included in PDL data;

FIG. 7 is a diagram illustrating a pattern command included in PDL data;

FIG. 8 is a diagram for describing a comparative example of a document storage unit;

FIG. 9 is a diagram for describing a document storage unit;

FIG. 10 is a flowchart for describing a processing method for storing a pattern;

FIG. 11 is a flowchart for describing a pattern searching process;

FIG. 12 is a diagram for describing the document storage unit; and

FIGS. 13A and 13B are diagrams for describing the document storage unit.

### DESCRIPTION OF THE EMBODIMENTS

An embodiment carrying out the technique of the present disclosure will be described below using the drawings.

### Embodiment 1

### [Configuration of Printer]

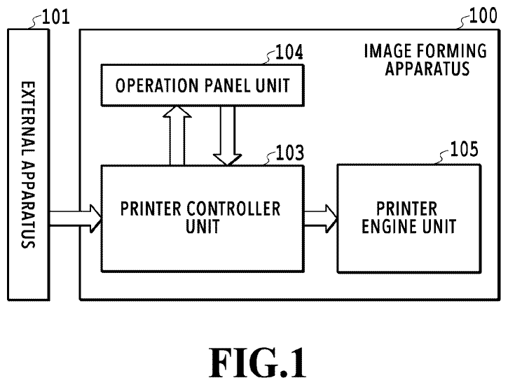

FIG. 1 is a block diagram illustrating a configuration of an image forming apparatus 100 as an example of a printing apparatus according to Embodiment 1. The image forming apparatus 100 has a printer controller unit 103, a printer engine unit 105, and an operation panel unit 104.

The printer controller unit 103 receives print data including various PDL data from an external apparatus 101, such as a host computer (hereinafter “host”). By analyzing that print data, bitmap data, which is image data (page information), is generated. The generated image data is sent to the printer engine unit 105 through an interface. The printer engine unit 105 forms an image represented by the image data generated by the printer controller unit 103 on a sheet by an electrophotographic process. The printer engine unit 105 includes mechanisms and an engine control unit that performs control associated with printing processes to be performed by those mechanisms. The operation panel unit 104 is a user interface. On the operation panel unit 104, the user performs input operations to instruct the image forming apparatus 100 to perform desired operations.

### [Configuration of Printer Controller Unit]

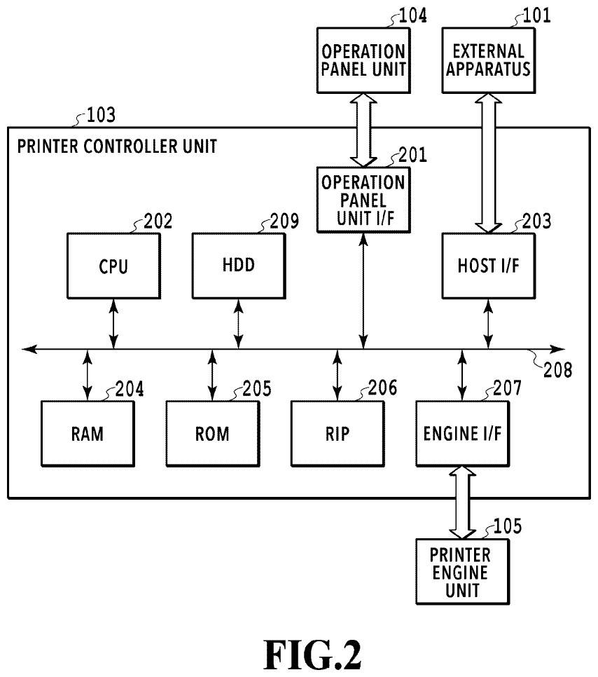

FIG. 2 is a diagram illustrating a configuration of the printer controller unit 103. A central processing unit (CPU) 202 controls the whole printer controller unit 103. The CPU 202 causes the printer controller unit 103 to function as an input-output unit for data including various PDL data to be sent to and received from the external apparatus 101.

A random-access memory (RAM) 204 is a system work memory for operation of the CPU 202, and is also an image memory to temporarily store input image data. A random-access memory (ROM) 205 stores control code for the system and programs for executing the processes to be described later. A hard disk drive (HDD) 209 stores system software for various processes, input image data, and so on.

The CPU 202 controls the entire image forming apparatus 100 and executes the processes to be described later by loading the control code and the programs stored in the ROM 205 to the RAM 204 and executing them. A host I/F 203 controls communication between the printer controller unit 103 and the external apparatus 101.

A raster image processor (RIP) 206 rasterizes PDL data into bitmap data. Following the control code stored in the ROM 205, the CPU 202 generates bitmap data which the printer engine unit 105 can process from PDL data input through the host I/F 203 with the RIP 206. The bitmap data is transferred to the printer engine unit 105 through an engine I/F unit 207 as a video signal. The engine I/F unit 207 is configured as an input-output unit for signals to be exchanged with the printer engine unit 105, and also controls communication with the printer engine unit 105.

An operation panel unit I/F 201 functions as an interface between the operation panel unit 104 and the CPU 202. Mode settings and the like designated by the user by operating the operation panel unit 104 are input into the CPU 202 through the operation panel unit I/F 201.

The CPU 202 controls the above-described blocks according to the mode settings designated through the operation panel unit 104. The CPU 202 executes this control based on the control code stored in the ROM 205. The above-described blocks including the CPU 202 are connected to the system bus 208 such that the CPU 202 can access them.

### [Function Framework]

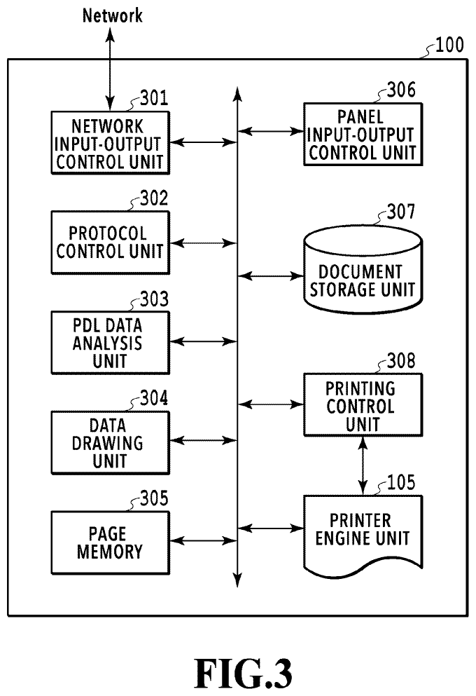

FIG. 3 is a block diagram illustrating functions in the image forming apparatus 100 associated with operations for image processing.

A network input-output control unit 301 functions as a printer interface and controls network input and output into and out of the external apparatus 101 through the host I/F 203. The network input-output control unit 301 receives PDL data sent from an external network and stores the received PDL data in a document storage unit 307.

A protocol control unit 302 communicates with an external apparatus by analyzing and sending a network protocol.

A PDL data analysis unit 303 obtains PDL data loaded to the document storage unit 307, analyzes the obtained PDL data, and converts each drawing object into intermediate data. A drawing object is, for example, text (text object), a figure (graphic object), a photograph (image object), or the like. The intermediate data generated by the PDL data analysis unit 303 is passed to a data drawing unit 304 through the document storage unit 307 and processed by the data drawing unit 304. Also, the PDL data analysis unit 303 is provided with a dedicated interpreter for each PDL type. In a case of receiving PDL data, the CPU 202 determines features of the PDL from the command syntax of the file format and identifies the PDL type to be analyzed by the PDL data analysis unit 303.

The data drawing unit 304 rasterizes the intermediate data into bitmap data by a drawing method with a scanline renderer. The rasterized bitmap data is sequentially drawn in a page memory 305. The page memory 305 temporarily holds the bitmap data to be rasterized by the data drawing unit 304 in the RAM 204, the HDD 209, or the like.

A panel input-output control unit 306 controls input and output into and out of the operation panel unit 104 through the operation panel unit I/F 201. The panel input-output control unit 306 performs control to display the bitmap data rasterized for reviewing in the page memory 305 as a preview image on the operation panel unit 104. Each time the bitmap data rasterized for reviewing in the page memory 305 is updated, the panel input-output control unit 306 performs control to display an updated preview image on the operation panel unit 104.

The document storage unit 307 is a memory implemented with the RAM 204 or a secondary storage device such as a hard disk drive including the HDD 209, and stores a data file containing vector data and intermediate data in the form of a single input document (job).

A printing control unit 308 converts the content of the page memory 305 into a video signal and transfers the image to the printer engine unit 105 through the engine I/F unit 207.

The CPU 202 implements the functional units in FIG. 3 by executing predetermined programs, but the present embodiment is not limited to this manner. Alternatively, for example, hardware such as a graphics processing unit (GPU) for speeding up computation or a field programmable gate array (FPGA) may be utilized. Each functional unit may be implemented by software and hardware, such as a dedicated integrated circuit (IC), cooperating with each other, or some or all of the functions may be implemented solely with hardware.

### [Pattern Commands]

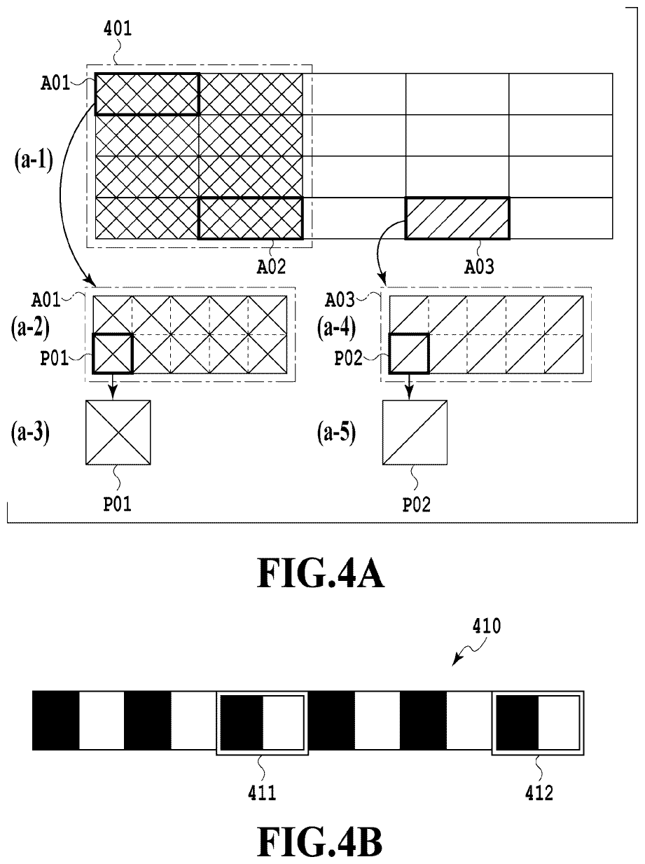

FIGS. 4A and 4B are diagrams illustrating examples of images represented by pattern commands contained in PDL data.

FIG. 4A is a diagram for describing an image generated by spreadsheet software, such as EXCEL (registered trademark). A predetermined range 401 illustrated in part (a-1) of FIG. 4A represents a region in a page formed of eight cells. The region is filled with the same patterns.

Part (a-2) of FIG. 4 is an enlarged view of a cell A01 which is one of the eight cells included in the predetermined range 401. Part (a-3) of FIG. 4 is an enlarged view of a pattern P01. As illustrated in FIG. 4A, the cell A01 is expressed by filling the entire cell with repetitions of the same pattern P01. Also, as with the cell A01, the eight cells included in the predetermined range 401 are filled with the patterns P01.

Part (a-4) of FIG. 4 is an enlarged view of a cell A03 which is a cell different from the cells included in the predetermined range 401. Part (a-5) of FIG. 4 is an enlarged view of a pattern P02 different from the pattern P01. The entire cell A03 is filled with repetitions of the pattern P02.

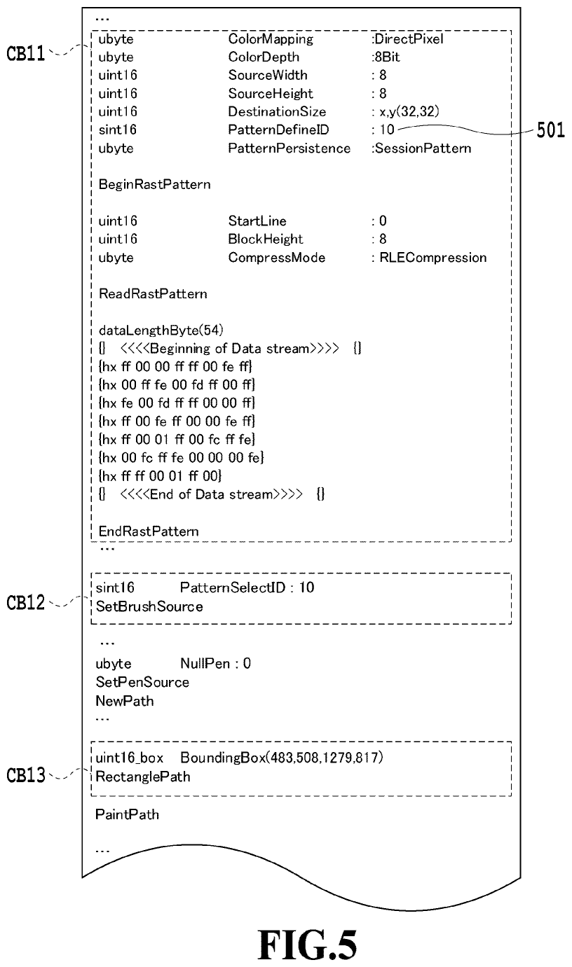

FIGS. 5, 6, and 7 are diagrams illustrating an example of pattern commands describing the content of the image of the predetermined range 401 in FIG. 4A and indicating part of PDL data. The following description will be given on the assumption that the page description language in the PDL data is PCL. For this reason, PDL data will also be referred to as “PCL data”.

FIG. 5 is a diagram illustrating a pattern command for drawing the cell A01 included in the predetermined range 401 in FIG. 4A. In the pattern command included in the PDL data, the pattern to be used for filling is defined. Specifically, as illustrated in a region CB11 in FIG. 5, the pattern command includes image data of the pattern P01, which is 54 bytes. As illustrated in a region 501 in the region CB11, an identifier with a value “10” (“PatternID”=“10”) is identified as an identifier corresponding to the pattern defined in the region CB11.

In a region CB12 in FIG. 5, a pattern with an identifier with the value “10” (“PatternID”=“10”) is defined as an image for “brush”. In the PCL command, “brush” is a color or image (pattern) with which to fill the inside of a figure. Also, a “pen (a color or image with which to color the outline of a figure)” command as a PCL command may be designated instead of “brush”.

In a region CB13 in FIG. 5, the two-dimensional positional range to be filled with repetitions of the defined pattern is defined. Specifically, the rectangular region corresponding to the cell A01 in FIG. 4A as a drawing region to be subjected to filling with the brush is defined using the coordinates of its upper left corner (483, 508) and the coordinates of its lower right corner (1279, 817). According to the pattern command in FIG. 5, the pattern defined as the image for “brush” in the region CB 12 (brush) will be repetitively drawn inside the drawing region defined in the region CB13 to fill the cell A01.

A command in PDL data for filling with a pattern is usually formed of three separate definitions, namely the definition of the pattern, like the region CB11, the definition of a brush, like the region CB12, and the definition of the drawing region (filling range), like the region CB13.

A pattern command represents commands and the like including three PCL commands like those in the region CB11 (BegineRastPattern, ReadRastPattern, EndRastPattern) and pattern definitions formed of accompanying attribute values.

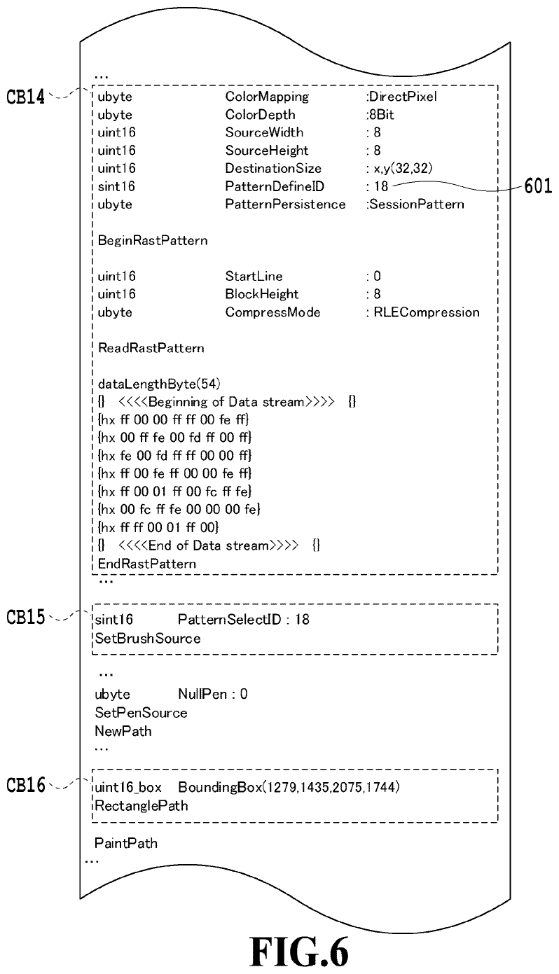

FIG. 6 is a diagram illustrating a pattern command for drawing a cell A02 included in the predetermined range 401 in FIG. 4A. The pattern used to fill the cell A02 is the same as that for the cell A01. Thus, as illustrated in a region CB14 in FIG. 6, the 54-byte pattern P01 is defined as an image for “brush”. In the pattern command of FIG. 6, however, as illustrated in a region 601 in the region CB14, an identifier with a value “18” (“PatternID”=“18”) is defined as an identifier corresponding to the pattern P01 defined in the region CB14.

While the predetermined range 401 in FIG. 4A is a range to be filled with the same pattern P01, the printer driver may generate an individual pattern command for each cell included in the predetermined range 401. In this case, the PDL data includes seven other pattern commands similar to FIG. 5, and the pattern command in FIG. 6 represents one of these. Also, in each of the pattern commands indicating the eight cells forming the predetermined range 401, a different identifier is defined for the pattern defined as the image for “brush”. That is, the pattern P01 is defined for each cell included in the predetermined range 401, and a different identifier is associated with the pattern P01 in each cell. Accordingly, in FIG. 6, an identifier with the value “18” (“PatternID”=“18”) is defined as an identifier corresponding to the pattern P01.

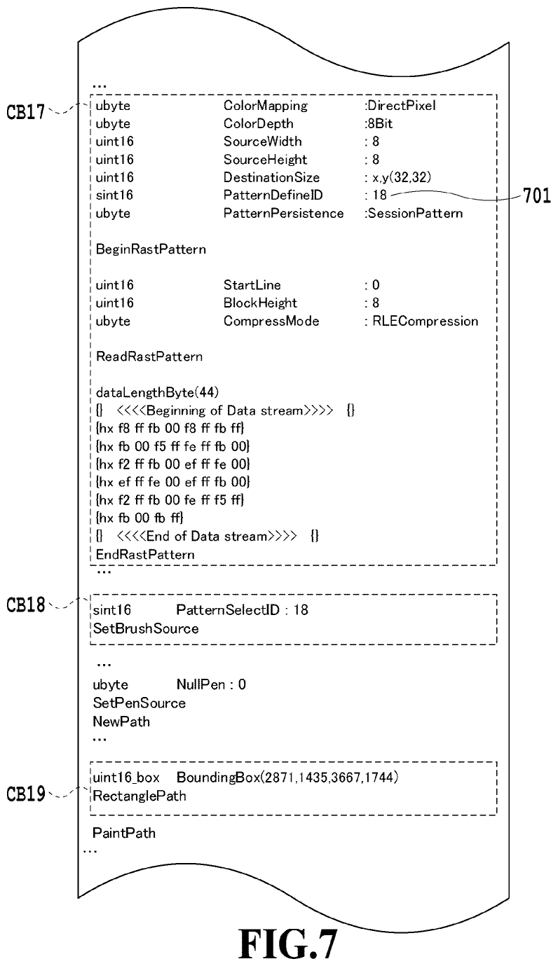

FIG. 7 is a diagram illustrating a pattern command for drawing the cell A03 in FIG. 4A. In the PDL data, the pattern P02 to be used to fill the inside of the cell A03 is defined. Specifically, as illustrated in a region CB17 in FIG. 7, the pattern P02, which is 44 bytes, is defined as an image associated with an identifier with the value “18” (“PatternID”=“18”). The specifications of PCL are such that the identifier of the pattern can reused. Thus, a pattern command (PCL data) in which an identifier that has been used once is associated with a different pattern or the same pattern is sometimes generated.

Note that PDL data generated differs by the printer driver. Thus, PDL data representing the content of an image generated by an application that is not spreadsheet software can be PDL data in which different identifiers are defined for the same patterns. FIG. 4B is an enlarged view of a ruled line 410 being a dotted line generated by an application that is not spreadsheet software. Suppose, for example, that PDL data representing the content of the ruled line 410 is such that a pattern including a single white portion and a single black portion for drawing a region 411 included in the ruled line 410 is defined as an image with an identifier “A”. Further, that PDL data may sometimes be such that the same pattern with that with the identifier “A” is defined as an image with an identifier “B” to be used to draw a region 412 included in the ruled line 410.

### [Comparative Example of Data Stored in Document Storage Unit]

As mentioned above, PDL data to be received by a printing apparatus may include a pattern command for each predetermined drawing region (cell), and a pattern may be defined in each pattern command. Image data of a pattern for “brush” defined in each pattern command identified as a result of analyzing the PDL data is stored in the document storage unit 307, and will be used to repetitively draw it inside the corresponding drawing region at the time of rasterization into bitmap data. A pattern whose image data is stored in the document storage unit 307 will also be referred to as “stored pattern”.

In a comparative example, the pieces of image data of all patterns defined in pattern commands in received PDL data are stored in the document storage unit 307. In this case, a plurality of pieces of image data of the same pattern may be stored in the document storage unit 307.

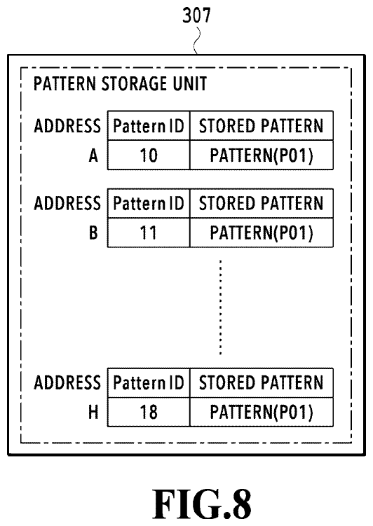

FIG. 8 is a diagram for describing the internal state of the document storage unit 307 in a case where patterns have been stored by the method of the comparative example. Suppose, for example, that PDL data representing an image with the predetermined range 401 filled with the pattern P01 as illustrated in FIG. 4A has been received, and that PDL data includes a pattern command for each of the eight cells forming the predetermined range 401. Thus, even in a case where the same pattern for “brush” is defined in the eight pattern commands, individual pieces of image data of the patterns for “brush” defined in the pattern commands for the eight cells are stored as illustrated in FIG. 8.

Thus, in the method of the comparative example, a plurality of pieces of image data of the same pattern may be stored. Specifically, in the method of the comparative example, a memory region required may become larger even in a case where the number of drawing regions to be filled with the same pattern increases. In this case, the load of the drawing process may increase, thereby deteriorating the printing performance of the image forming apparatus 100. One may consider adding hardware, e.g., increasing the number of memories forming the document storage unit 307, but adding hardware increases the cost.

### [Data Stored in Document Storage Unit in Present Embodiment]

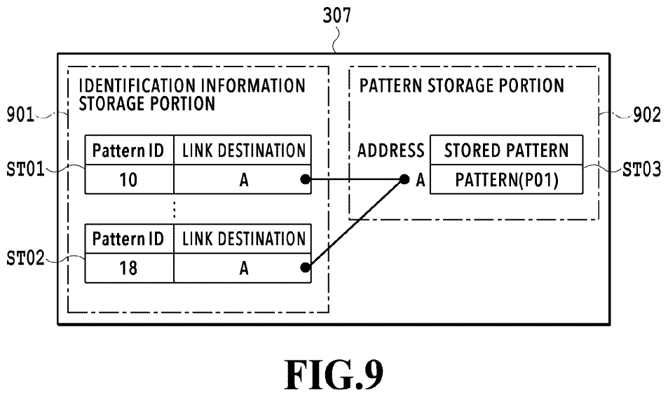

FIG. 9 is a diagram for describing the document storage unit 307 in the present embodiment. The PDL data analysis unit 303 secures storage regions in the document storage unit 307 for an identification information storage portion 901 and a pattern storage portion 902 as needed. In the document storage unit 307 in the present embodiment, identifiers and the corresponding pieces of image data are separately stored. The identifiers of patterns (PatternIDs) and the pieces of image data of the patterns are managed such that the former is stored in the identification information storage portion 901 and the latter is stored in the pattern storage portion 902.

The identification information storage portion 901 is a storage region to store identifiers associated with patterns defined in respective pattern commands included in PDL data.

In each of the pattern commands for the eight cells forming the predetermined range 401, a different identifier is defined for the pattern P01 defined in the pattern command. For example, the eight identifiers in the pattern commands forming the predetermined range 401 are each associated with the same pattern P01. Thus, eight identifiers among values “10” to “18” are stored in the identification information storage portion 901.

The pattern storage portion 902 is a region to store the pieces of image data of the patterns defined as the images for “brush” in the pattern commands. In the present embodiment, unlike the comparative example, for each pattern command, whether to store the image data of the pattern defined in the pattern command is determined, and the image data of the pattern determined to be stored is stored in the pattern storage portion 902. Details will be described later.

In FIG. 9, the identifiers stored in the identification information storage portion 901 are associated (linked) with an address in the pattern storage portion 902 at which the image data of the corresponding pattern is stored. The image data of a pattern stored in the pattern storage portion 902 can be associated with a plurality of identifiers. Thus, in the present embodiment, unlike the comparative example, the image data of a pattern does not need to be stored for each single identifier.

The solid lines in FIG. 9 indicate the associations (links) between identifiers and the image data of a stored pattern associated with the identifiers. In the present embodiment, in a case where an identifier and a stored pattern need to be associated with each other, a memory address value (address) is set in the pattern storage portion 902. Then, a link is created in the document storage unit 307 so that the image data of the stored pattern in the pattern storage portion 902 can be referred to with the identifier.

### [Pattern Storage Process]

In the present embodiment, as illustrated in FIG. 9, the identifiers of patterns are stored separately from image data. Moreover, a plurality of identifiers are associated with the image data of a single stored pattern to reduce the image data of patterns that would otherwise be stored in the document storage unit 307, which is a memory region in the present embodiment. The PDL data analysis unit 303 performs this process in a case of analyzing a pattern command.

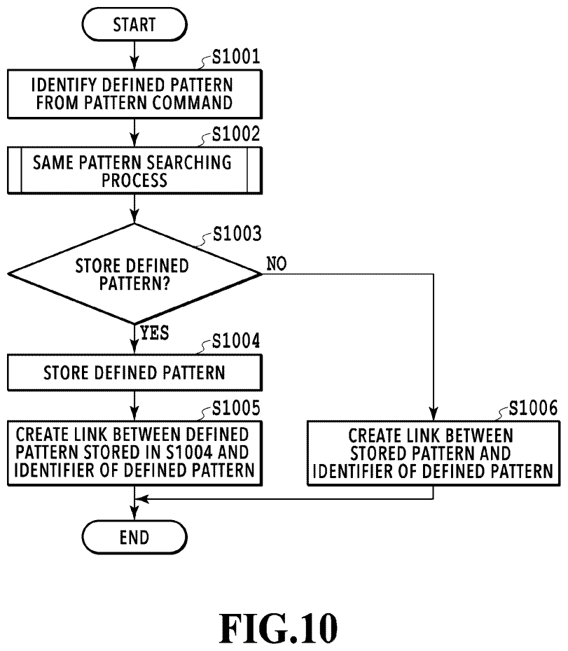

FIG. 10 is a flowchart for describing a processing method for the PDL data analysis unit 303 in a case of storing the image data of a pattern defined in a pattern command into the document storage unit 307. By loading program code stored in the ROM 205 or the HDD 209 to the RAM 204 and executing it, the CPU 202 implements the functional units to execute the series of processes in the steps illustrated in the flowchart of FIG. 10. Also, the functions of some or all of the steps in FIG. 10 may be implemented with hardware such as an ASIC or an electronic circuit. The symbol “S” in the description of each process means a step in the flowchart. This applies also to the subsequent flowchart.

Each time received PDL data is analyzed and a pattern command is identified, the processing in FIG. 10 is performed on the identified pattern command. That is, the processing in the flowchart of FIG. 10 is performed for a set of PCL commands (BegineRastPattern, ReadRastPattern, EndRastPattern).

First of all, the flowchart of FIG. 10 will be described based on a case where the processing-target pattern command is the pattern command in FIG. 5 as an example. Suppose that the pattern command in FIG. 5 is a pattern command that is analyzed first in a case where the input PDL data is analyzed, and therefore that the identifier and the image data are not stored in the document storage unit 307.

In S1001, the PDL data analysis unit 303 starts analyzing the processing-target pattern command included in the PDL data, and identifies the pattern defined in the processing-target pattern command as the image for “brush”. The pattern identified in this step will be referred to as “the defined pattern of the processing-target pattern command”. In the following steps, a process is performed on the defined pattern. In the case where the processing-target pattern command is the pattern command in FIG. 5, the pattern defined in the region CB11 in FIG. 5 is identified as the defined pattern.

In S1002, the PDL data analysis unit 303 searches for the same pattern as the defined pattern from among the stored patterns in the pattern storage portion 902 of the document storage unit 307. As a result of the search, a setting value indicating whether the same pattern is stored is obtained.

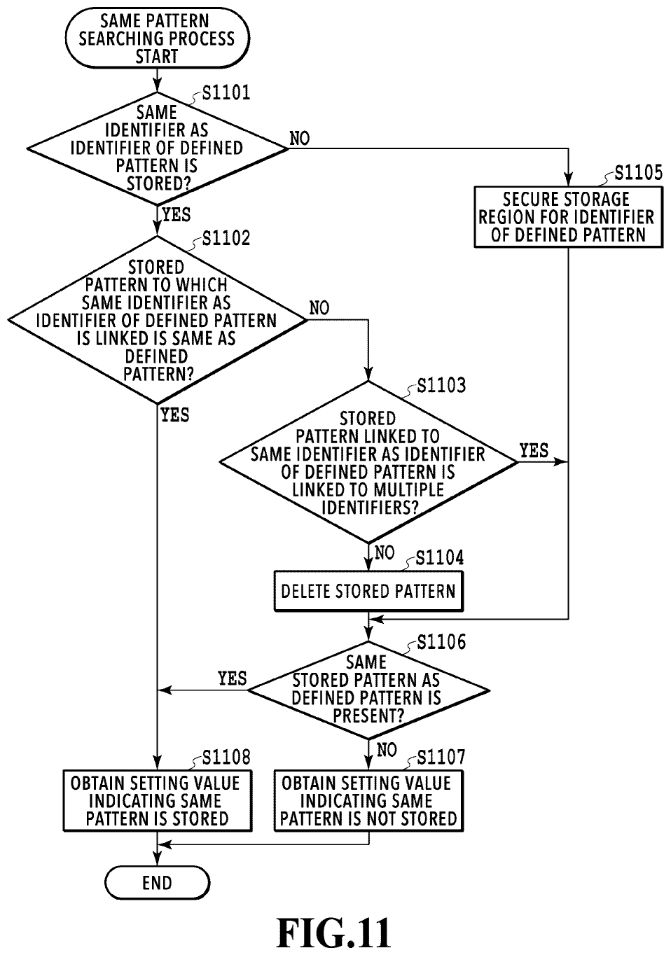

FIG. 11 is a flowchart for describing details of the process in S1002.

In S1101, the PDL data analysis unit 303 identifies the identifier associated with the defined pattern from the processing-target pattern command. The PDL data analysis unit 303 determines whether the same identifier as the identified identifier (the identifier of the defined pattern) is stored in the identification information storage portion 901 of the document storage unit 307.

If determining that the same identifier as the identifier of the defined pattern is stored in the identification information storage portion 901 (YES in S1101), the PDL data analysis unit 303 advances the processing to S1102. Description of S1102 to S1104 will be given later. If determining that the same identifier as the identifier of the defined pattern is not stored in the identification information storage portion 901 (NO in S1101), the PDL data analysis unit 303 advances the processing to S1105.

In S1105, the PDL data analysis unit 303 secures a storage region to store the identifier of the defined pattern in the identification information storage portion 901 of the document storage unit 307, and stores the identifier of the defined pattern in the secured storage region. The PDL data analysis unit 303 advances the processing to S1106.

In the case where the processing-target pattern command is FIG. 5, a storage region ST01 illustrated in FIG. 9 is secured as the storage region for the identifier with the value “10” (“PatternID”=“10”). Then, the PDL data analysis unit 303 stores the identifier with the value “10” (“PatternID”=“10”) defined as the identifier of the defined pattern in the pattern command in FIG. 5 into the storage region ST01.

In S1106, the PDL data analysis unit 303 determines whether the same pattern as the defined pattern is present among the stored patterns in the pattern storage portion 902. The determination in S1106 may be executed such that the number of stored patterns in the pattern storage portion 902 to be compared with the defined pattern is limited to a predetermined number or less. Reducing the number of searches will lower the processing load.

If determining that the same pattern as the defined pattern is stored in the pattern storage portion 902 (YES in S1106), the PDL data analysis unit 303 advances the processing to S1108. In S1108, the PDL data analysis unit 303 obtains a setting value indicating that the same pattern is stored. Then, the PDL data analysis unit 303 terminates the flowchart of FIG. 11 and moves to S1003 in the flowchart of FIG. 10.

If, on the other hand, determining that the same pattern as the defined pattern is not stored in the pattern storage portion 902 (NO in S1106), the PDL data analysis unit 303 advances the processing to S1107. In S1107, the PDL data analysis unit 303 obtains a setting value indicating that the same pattern is not stored. Then, the PDL data analysis unit 303 terminates the flowchart of FIG. 11 and moves to S1003 in the flowchart of FIG. 10.

The pattern command in FIG. 5 is the first pattern command in the PDL data. In the case where the pattern command in FIG. 5 is the processing target, it is determined NO in S1106 since the image data of the pattern is not stored in the pattern storage portion 902, and the setting value indicating that the same pattern is not stored is obtained in S1107.

In S1003 in FIG. 10, the PDL data analysis unit 303 determines whether to store the image data of the defined pattern based on the result of the search in S1002. The PDL data analysis unit 303 determines that the image data of the defined pattern is to be stored if the setting value indicating the same pattern is not stored has been obtained as the result of the process in S1002. The PDL data analysis unit 303 determines that the image data of the defined pattern is not to be stored if the setting value indicating the same pattern is stored has been obtained as the result of the process in S1002.

If determining that the image data of the defined pattern is to be stored (YES in S1003), the PDL data analysis unit 303 advances the processing to S1004. If determining that the image data of the defined pattern is not to be stored (YES in S1003), the PDL data analysis unit 303 advances the processing to S1006. The process in S1006 will be described later.

In the case where the pattern command in FIG. 5 is the processing target, the setting value indicating that the same pattern is not stored is obtained as the result of the process in S1002, so that it is determined YES in S1003, and the processing proceeds to S1004.

In S1004, the PDL data analysis unit 303 stores the image data of the defined pattern included in the processing-target pattern command in the pattern storage portion 902. In the case of the pattern command in FIG. 5, the information in the region CB11 defining the pattern P01 is newly stored in the pattern storage portion 902. Suppose that the image data of the pattern P01 is stored in a storage region ST03 whose memory address value in the pattern storage portion 902 is an address A, as illustrated in FIG. 9.

In S1005, the PDL data analysis unit 303 creates a link inside the document storage unit 307 such that the identifier of the defined pattern defined in the processing-target pattern command and the image data of the pattern stored in S1004 are associated with each other.

In the case of the pattern command in FIG. 5, a memory address value indicating the address A storing the pattern command P01 is stored in the storage region ST01 in the identification information storage portion 901 storing the identifier with the value “10” (“PatternID”=“10”). Thus, a link is created between the identifier of the defined pattern defined in the processing-target pattern command and the image data of the defined pattern newly stored in the document storage unit 307. The above is the processing for storing a pattern.

A drawing process of filling the drawing region defined in the pattern command in FIG. 5 included in PDL data with a pattern based on the pattern command and the data stored in the document storage unit 307 will now be described.

The data drawing unit 304 obtains the value “10” of the identifier (“PatternID”=“10”) defined in the region CB12 in the pattern command in FIG. 5. The data drawing unit 304 defines the image data of the pattern P01 associated with the identifier with the value “10” (“PatternID”=“10”) in the document storage unit 307 as the image data for “brush”. The data drawing unit 304 repetitively draws the defined pattern P01 (brush) in the drawing region defined in the region CB13 in the pattern command in FIG. 5 (the rectangular region having an upper left corner at coordinates (483, 508) and a lower right corner at coordinates (1279, 817)). As a result, the cell A01, which is the drawing region, is drawn by filling.

Next, the flowchart of FIG. 10 will be described based on a case where the processing-target pattern command is the pattern command in FIG. 6 as an example. Suppose that the pattern command in FIG. 6 is a pattern command that is analyzed after the pattern command in FIG. 5 and therefore that the identifier with the value “18” (“PatternID”=“18”) is not stored in the identification information storage portion 901 of the document storage unit 307. Suppose also that the image data of the pattern P01 is stored in the pattern storage portion 902 and associated with the identifier with the value “10” (“PatternID”=“10”). Steps that have already been described will be described without details of the processes.

The pattern command in FIG. 6 is such that the identifier defined therein (PatternID”=“18”) is not stored in the identification information storage portion 901 but the pattern defined for the brush is the same as the stored pattern. Processing by the PDL data analysis unit 303 on a pattern command in which the same pattern as a stored pattern is defined will now be described using FIG. 6.

In S1001, the pattern defined in the region CB14 in FIG. 6 is identified as the defined pattern. The pattern defined in the region CB14 is the pattern P01. Thus, the pattern P01 is identified as the defined pattern and subjected to the processes in the subsequent steps.

In S1002, the processes in the flowchart of FIG. 11 are performed.

In S1101, the PDL data analysis unit 303 determines that the identifier with the value “18” (“PatternID”=“18”) defined in the pattern command in FIG. 6, which is the processing target, is not stored in the identification information storage portion 901 (NO in S1101). Thus, the PDL data analysis unit 303 advances the processing to S1105.

In S1105, the PDL data analysis unit 303 secures a storage region ST02 illustrated in FIG. 9 as a storage region for the identifier with the value “18” (“PatternID”=“18”). The PDL data analysis unit 303 then stores the identifier with the value “18” (“PatternID”=“18”) in the storage region ST02.

In S1106, the pattern P01, which is the same as the defined pattern, is stored in the storage region ST03 in the pattern storage portion 902. Thus, the PDL data analysis unit 303 determines that the same pattern as the defined pattern is stored in the pattern storage portion 902 (YES in S1106), and advances the processing to S1108.

In S1108, the PDL data analysis unit 303 obtains the setting value indicating that the same pattern is stored, and advances the processing to S1003 in FIG. 10.

In S1003 in FIG. 10, the PDL data analysis unit 303 determines that the defined pattern is not to be stored (NO in S1003) since the setting value indicating that the same pattern is stored has been obtained as a result of the process in S1002, and the processing proceeds to S1006.

In S1006, the PDL data analysis unit 303 creates a link inside the document storage unit 307 such that the identifier defined in the processing-target pattern command and the stored image data of the same pattern as the defined pattern are associated with each other.

FIG. 9 illustrates the state of the document storage unit 307 after implementing the flowcharts of FIGS. 10 and 11 on the pattern commands in FIGS. 5 and 6. Suppose that the stored pattern P01 determined to be the same as the defined pattern identified from the pattern command in FIG. 6 is stored in the storage region ST03, whose memory address value in the pattern storage portion 902 is the address A. In this case, in S1006, the memory address value of the pattern P01, or the address A, is stored in the storage region ST02 in the identification information storage portion 901 storing the identifier “18” defined in the processing-target pattern command.

As a result, a link is created between the identifier defined in the processing-target pattern command and the image data of the same stored pattern as the defined pattern is created in the document storage unit 307. Moreover, links are created such that the image data of a single stored pattern can be referred to from a plurality of identifiers. The above is the processing for storing a pattern.

In the drawing process for the pattern command in FIG. 6, the data drawing unit 304 obtains the identifier with the value “18” (“PatternID”=“18”) defined in a region CB15 in the pattern command in FIG. 6. The data drawing unit 304 then defines the image data of the pattern P01 associated with the identifier with the value “18” (“PatternID”=“18”) in the document storage unit 307 as the image for “brush”. The data drawing unit 304 repetitively draws the defined pattern P01 (brush) in the drawing region defined in a region CB16 in the pattern command in FIG. 6 (the rectangular region having an upper left corner at coordinates (1279, 1453) and a lower right corner at coordinates (2075, 1744)). As a result, the cell A02, which is the drawing region, is drawn by filling.

Next, a description will be given of processing in a case where an identifier with the same value as an identifier defined in a pattern command has already been stored in the identification information storage portion 901, and the defined pattern is not the same as the stored pattern associated with that identifier. Specifically, the flowchart of FIG. 10 will be described based on a case where the processing-target pattern command is the pattern command in FIG. 7 as an example. Suppose that the pattern command in FIG. 7 is a pattern command that is analyzed after the pattern commands in FIGS. 5 and 6 and also that identifiers and the image data of a pattern are stored in the document storage unit 307 in the state illustrated in FIG. 9. Steps that have already been described will be described without details of the processes.

In S1001, the pattern defined in the region CB17 in the pattern command in FIG. 7 is identified as the defined pattern. The pattern defined in the region CB17 in FIG. 7 is the pattern P02. Thus, the pattern P02 is subjected to the processes in the subsequent steps as the defined pattern.

In S1002, the processes in the flowchart of FIG. 11 are performed.

As illustrated in FIG. 9, the identifier with the value “18” (“PatternID”=“18”) defined in the pattern command in FIG. 7, which is the processing target, is already stored in the identification information storage portion 901. Thus, in S1101, the PDL data analysis unit 303 determines that the identifier of the defined pattern is stored in the identification information storage portion 901 (YES in S1101) and advances the processing to S1102.

In S1102, the PDL data analysis unit 303 refers to the stored pattern associated with the identifier having the same value as the identifier of the defined pattern in the document storage unit 307. The PDL data analysis unit 303 then determines whether the stored pattern thus referred to is the same pattern as the defined pattern.

If determining that the stored pattern and the defined pattern are the same (YES in S1102), the PDL data analysis unit 303 advances the processing to S1108. If determining that the stored pattern and the defined pattern are not the same (NO in S1102), the PDL data analysis unit 303 advances the processing to S1103.

In the case where the processing-target pattern command is FIG. 7, the identifier of the defined pattern is the identifier with the value “18” (“PatternID”=“18”). Thus, the PDL data analysis unit 303 refers to the pattern P01 in the storage region ST03 in the document storage unit 307, which is associated with the identifier with the value “18” (“PatternID”=“18”). The PDL data analysis unit 303 then determines whether the stored pattern P01 in the storage region ST03 and the pattern P02, which is the defined pattern, are the same pattern. The PDL data analysis unit 303 determines that the patterns P01 and P02 are not the same (NO in S1102), and the processing therefore proceeds to S1103.

In S1103, the PDL data analysis unit 303 determines whether the image data of the stored pattern associated with the identifier having the same value as the identifier of the defined pattern is associated with a plurality of identifiers in the document storage unit 307.

In the case where the document storage unit 307 is in the state of FIG. 9, the pattern in the storage region ST03, which is associated with the identifier with the value “18” (“PatternID”=“18”), is also associated with another identifier (“PatternID”=“10”). Thus, in the case where the document storage unit 307 is in the state of FIG. 9, the PDL data analysis unit 303 determines that the stored pattern is associated with a plurality of identifiers (YES in S1103).

If determining that the stored pattern is associated with a plurality of identifiers (YES in S1103), the PDL data analysis unit 303 skips S1104 and advances the processing to S1106.

In S1106, the PDL data analysis unit 303 determines whether the same pattern as the defined pattern is present among the stored patterns in the pattern storage portion 902, as described earlier.

In the case where the pattern command in FIG. 7 is the processing target and the document storage unit 307 is in the state of FIG. 9, the pattern P01 is the only stored pattern in the pattern storage portion 902. Thus, the PDL data analysis unit 303 determines that the stored pattern is not the same as the defined pattern, or the pattern P02 (NO in S1106), and advances the processing to S1107. In S1107, the PDL data analysis unit 303 obtains the setting value indicating that the same pattern is not stored, and the flowchart of FIG. 11 ends. The processing then proceeds to S1003.

In S1003 in FIG. 10, the PDL data analysis unit 303 determines that the defined pattern is to be stored (YES in S1003) since the setting value indicating that the same pattern is not stored has been obtained as a result of the process in S1002, and advances the processing to S1004.

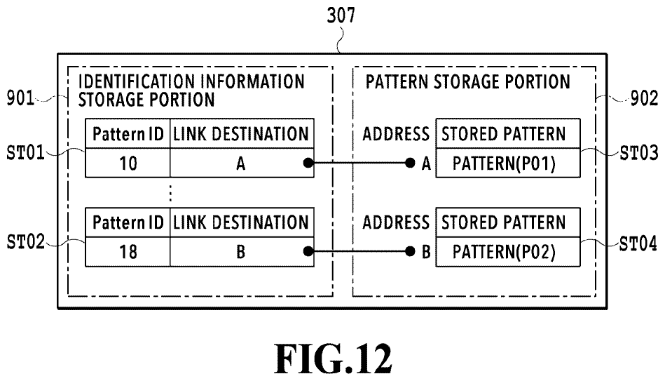

In the case where the pattern command in FIG. 7 is the processing target, in S1004, the PDL data analysis unit 303 newly stores the image data of the defined pattern, or the pattern P02, in a storage region ST04 (see FIG. 12) in the pattern storage portion 902.

In S1005, the PDL data analysis unit 303 stores the identifier defined in the processing-target pattern command in association with the image data of the pattern newly stored in S1004.

As illustrated in FIG. 7, the identifier of the defined pattern defined in the processing-target pattern command is the value “18”. Thus, in S1005, the PDL data analysis unit 303 stores a memory address value indicating an address B storing the image data of the pattern P02, which is the same as the defined pattern, in the storage region ST02 for the identifier with the value “18” (“PatternID”=“18”). As a result, a link is created between the identifier (“PatternID”=“18”) and the image data of the pattern P02. The above is the processing for storing a pattern.

FIG. 12 is a diagram illustrating the state of the data stored in the document storage unit 307 after performing the processes in FIG. 10 on the pattern command in FIG. 7 as the processing target. As a result of performing the processes on the pattern command in FIG. 7, the link relationship between the identification information storage portion 901 and the pattern storage portion 902 has changed from the state of the document storage unit 307 in FIG. 9.

In the drawing process for the pattern command in FIG. 7, the data drawing unit 304 obtains the identifier with the value “18” (“PatternID”=“18”) defined in a region CB18 in the pattern command in FIG. 7. The data drawing unit 304 then defines the pattern P02 associated with the identifier with the value “18” (“PatternID”=“18”) in the document storage unit 307 in FIG. 12 as the image for “brush”. The data drawing unit 304 repetitively draws the defined pattern P02 (brush) in the drawing region defined in the region CB13 in the pattern command in FIG. 7 (the rectangular region having an upper left corner at coordinates (2871, 1435) and a lower right corner at coordinates (3667, 1744)). As a result, the cell A03, which is the drawing region, is drawn by filling.

As described above, even in a case where the processing target is a pattern command in which the same identifier as an identifier stored in the identification information storage portion 901 is defined and a new pattern is defined, the link relationship between the identifiers and the pieces of image data of the patterns can be changed. This prevents a plurality of patterns from being stored in the document storage unit 307.

On the other hand, if determining in S1103 in FIG. 11 that the stored pattern associated with the identifier in the defined pattern is not associated with a plurality of identifiers (NO in S1103), the PDL data analysis unit 303 advances the processing to S1104. In S1104, the PDL data analysis unit 303 deletes the image data of the stored pattern associated with the identifier having the same value as the identifier of the defined pattern in the document storage unit 307. The PDL data analysis unit 303 then advances the processing to S1106.

Suppose, for example, that a pattern command in which the identifier with the value “18” (“PatternID”=“18”) and a pattern P03 are defined is the processing target in the flowchart of FIG. 10, and also that identifiers and the pieces of image data of patterns are stored in the document storage unit 307 in the state illustrated in FIG. 12. As illustrated in FIG. 12, the stored pattern associated with the identifier of the defined pattern, or the identifier with the value “18”, is the pattern P02, which is associated with only one identifier. Thus, the processing in the flowchart of FIG. 11 proceeds to S1104, in which the image data of the pattern P02 stored in the storage region ST04 in the pattern storage portion 902 in FIG. 12 is deleted. Then, in S1004, the image data of the pattern P03 is stored in the pattern storage portion 902. In S1005, a link is created between the identifier of the defined pattern, or the identifier with the value “18”, and the image data of the pattern P03 in the document storage unit 307.

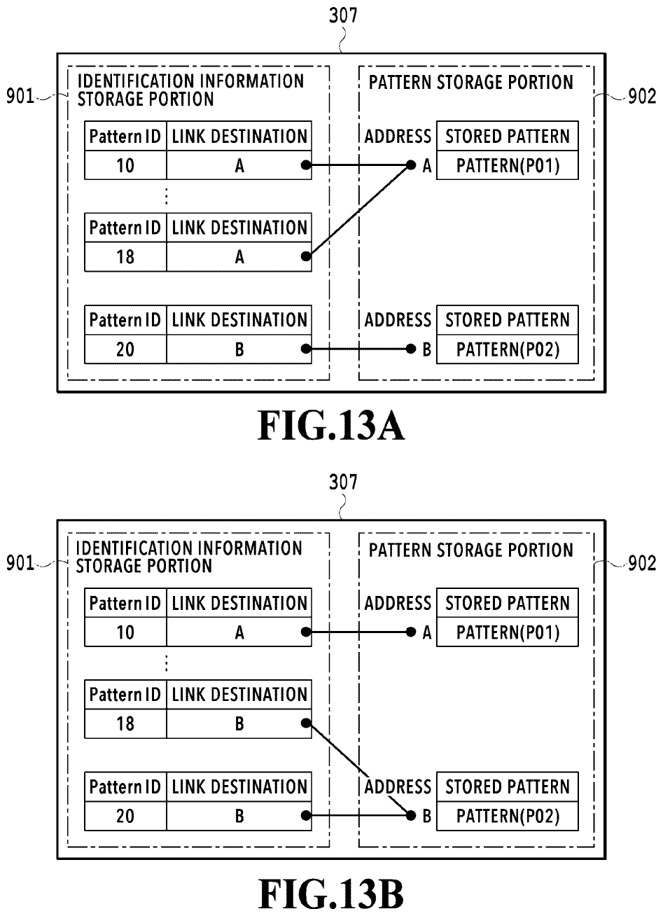

Suppose also that the pattern command in FIG. 7 is the processing target in the flowcharts FIGS. 10 and 11 in a case where identifiers and the pieces of image data of patterns are stored in the document storage unit 307 in the state illustrated in FIG. 13A, for example.

In this case, in the flowchart of FIG. 11, it is determined YES in S1101, NO in S1102, YES in S1103, and YES in S1106, so that the processing transitions to S1108. Moreover, it is determined NO in S1003, so that the processing proceeds to S1006.

In S1006, as described earlier, a link is created inside the document storage unit 307 such that the identifier of the defined pattern and the image data of the same pattern as the defined pattern among the stored patterns in the pattern storage portion 902 are associated with each other.

FIG. 13B is a diagram illustrating the state of the document storage unit 307 after the process in S1006. The identifier with the value “18” (“PatternID”=“18”) defined in the pattern command in FIG. 7 and the image data of the pattern P02 in the pattern storage portion 902 are associated with each other. As illustrated in FIG. 13A, before the process, the identifier with the value “18” was stored in the identification information storage portion 901 and associated with the image data stored pattern P01, but this association is eliminated. The specifications of PCL are such that the same identifier may be reused. Thus, links can be recreated as above.

As described above, in the present embodiment, in the analysis of a pattern command, a defined pattern identified from the pattern command and stored patterns in the pattern storage portion 902 are compared with each other. In a case where there is a pattern that is the same as the defined pattern in the pattern storage portion 902, the defined pattern is deleted without being stored, and the address of the stored pattern is stored in the identification information storage portion 901 such that the identifier of the defined pattern and the stored pattern are linked to each other. In this way, patterns can be managed such that a single piece of image data is stored for the same pattern in the memory. Moreover, a plurality of identifiers can be linked to the image data of a single pattern stored in the pattern storage portion 902.

The description of a pattern in generated PDL data varies by the printer driver. In PDL data describing a content designating repetitive drawing of the same pattern in a predetermined range to fill the predetermined range, the same pattern may be defined in every predetermined region in the predetermined range. In the present embodiment, even in a case where such PDL data is received, the number of patterns to be stored in the memory region for the drawing is prevented from increasing. That is, in a case where performing a drawing process based on PDL data involves drawing the same pattern in a plurality of regions, it is possible to repetitively designate and reuse a pattern that has already been stored to perform the drawing. Accordingly, it is possible to prevent the deterioration of the printing performance due to an increase of the number of patterns to be stored in the memory region without having to add hardware.

Note that, in the description of the present embodiment, pattern commands described in PCL have been presented as an example of analysis targets. Commands for a pattern (a unit image to be repetitively used in filling) are not limited to pattern command described in PCL. Also, the page description language is not limited to PCL such as PCLXL or PCL5, and the present embodiment is applicable also to PDL data described in other page description languages.

The present embodiment may be applied to a system formed of a plurality of pieces of equipment or an apparatus formed of a single piece of equipment. For example, the apparatus including the functional units in FIG. 3 may be implemented with an image processing apparatus different from the image forming apparatus 100.

With the technique of the present disclosure, it is possible to prevent an increase of a memory region that is needed to generate bitmap data based on PDL data in which a plurality of patterns are defined.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-149904 filed Sep. 15, 2023, which is hereby incorporated by reference wherein in its entirety.

What is claimed is:

1. An image processing apparatus for generating bitmap data based on PDL data, comprising:
an obtaining unit configured to obtain the PDL data;
an identification unit configured to, in a case where PDL data including a command indicating repetitively drawing of a pattern in a predetermined range in a page is obtained, identifies the pattern defined in the command; and
a control unit configured to store image data of the identified pattern in a memory, wherein
the control unit controls the storage of the image data of the identified pattern such that a single piece of image data is stored for same patterns in the memory.

2. The image processing apparatus according to claim 1, wherein
in a case where image data of a same pattern as the identified pattern is not stored in the memory, the control unit stores the image data of the identified pattern in the memory in association with an identifier corresponding to the identified pattern, and
in a case where image data of the same pattern as the identified pattern is stored in the memory, the control unit does not store the image data of the identified pattern in the memory and associates the image data of the same pattern as the identified pattern among pieces of image data stored in the memory with the identifier corresponding to the identified pattern.

3. The image processing apparatus according to claim 1, wherein
the PDL data includes a plurality of the commands, and
the identification unit identifies a pattern defined in each of the plurality of commands.

4. The image processing apparatus according to claim 2, further comprising
a determination unit configured to compare the image data of the identified pattern and image data stored in the memory, and determine whether the image data of the same pattern as the identified pattern is stored or not in the memory, wherein
in a case where the determination unit determines that the image data of the same pattern as the identified pattern is not stored in the memory, the control unit stores the image data of the identified pattern in the memory in association with the identifier corresponding to the identified pattern.

5. The image processing apparatus according to claim 4, wherein
the determination unit limits the number of pieces of image data stored in the memory which are to be compared to the image data of the identified pattern to a predetermined number.

6. The image processing apparatus according to claim 1, wherein
the identification unit identifies the identifier corresponding to the identified pattern from the command, and
in a case where a same identifier as the identified identifier is not stored in the memory, the control unit stores the identified identifier in the memory in association with the image data of the identified pattern.

7. The image processing apparatus according to claim 6, wherein
in a case where the same identifier as the identified identifier is stored in the memory and image data of a same pattern as the identified pattern is stored in the memory, the control unit changes the image data to be associated with the identified identifier.

8. The image processing apparatus according to claim 1, further comprising
a drawing unit configured to generate the bitmap data by performing drawing based on the PDL data, wherein
the image data of the pattern stored by the control unit is used in a case where the drawing unit repetitively draws the pattern in the predetermined range.

9. The image processing apparatus according to claim 1, wherein
a page description language in the PDL data is Printer Command Language (PCL).

10. The image processing apparatus according to claim 1, wherein
the PDL data includes a plurality of the commands, and
the PDL data is PDL data in which a pattern and an identifier corresponding to the pattern are defined for each of the plurality of the commands.

11. The image processing apparatus according to claim 1, wherein
the pattern is a unit image to be repetitively drawn in the predetermined range.

12. An image processing method for generating bitmap data based on PDL data, comprising:
obtaining the PDL data;
in a case where PDL data including a command indicating repetitively drawing of a pattern in a predetermined range in a page is obtained, identifying the pattern defined in the command; and
storing image data of the identified pattern in a memory, wherein
the storage of the image data of the identified pattern is controlled such that a single piece of image data is stored for same patterns in the memory.

13. A non-transitory computer readable storage medium storing a program which causes a computer to perform an image processing method for generating bitmap data based on PDL data, the image processing method comprising:
obtaining the PDL data;
in a case where PDL data including a command indicating repetitively drawing of a pattern in a predetermined range in a page is obtained, identifying the pattern defined in the command; and
storing image data of the identified pattern in a memory, wherein
the storage of the image data of the identified pattern is controlled such that a single piece of image data is stored for same patterns in the memory.
